(19) United States
(12) Patent Application Publication
(10) Pub. No.: US 2012/0310517 A1
(43) Pub. Date: Dec. 6, 2012

(54) METHOD FOR WARNING A USER OF A ROAD VEHICLE ABOUT AN APPROACHING VEHICLE

(76) Inventor: Jacob van den Oever, Den Haag (NL)

(21) Appl. No.: 13/520,898

(22) PCT Filed: Jan. 10, 2011
(86) PCT No.: PCT/NL11/50016

§ 371 Date: Jul. 27, 2012

(30) Foreign Application Priority Data
Jan. 8, 2010 (EP) EP 10150302.7

(51) Int. Cl. G08G 1/0962

(52) U.S. Cl. 701/300

(57) ABSTRACT

A method for alerting a user of a road vehicle (B-F, 4) for a neighbouring priority vehicle (A, 1) is provided. First data, indicating to the current position of the priority vehicle and the next part of its planned route, are transmitted to other road vehicles the road vehicle and/or its user. The road vehicle and/or its user receives the first data and compares it to second data, indicating the current position of the road vehicle and/or the next part of its planned route. An alert is output to the user when the comparison of the first and second data indicates that the current position or any position within the next part of the planned route of the priority vehicle will coincides with the current position or any position within the next part of a planned route of the road vehicle. The next part of the planned route of the priority vehicle or road vehicle respectively may cover at least the next two road intersections along its planned route, making it possible to provide selective warnings for possible coincidence of the vehicles beyond the next intersection.

### FIELD OF THE INVENTION

The invention relates to a method and system for alerting a user of a road vehicle about an approaching vehicle, in particular approaching priority vehicles such as an ambulance, police car, or fire engine.

### BACKGROUND

U.S. Pat. No. 7,446,674 proposes an emergency warning system arranged to detect a predefined signal emitted by a priority vehicle in this patent application) such as an ambulance, police car, fire engine (called a right of way vehicle in U.S. Pat. No. 7,446,674). The right of way vehicle transmits a specific predefined signal to a predefined area. The signal is picked up by a receiver of the emergency warning system, which may be housed in a rear view mirror of a road vehicle or a cell phone of the driver. After verification of the signal warning system emits a warning, preferably an audio warning from a speaker housed in the internal rear view mirror or cell phone or telematics unit.

U.S. Pat. No. 6,529,831 discloses a system for alerting drivers of approaching emergency vehicles and vice versa. The system comprises a navigation information system, such as a GPS system, in each vehicle. The navigation information system is used to determine the location and speed of the vehicle. From the location and speed information of the vehicles it is determined whether the vehicles are likely to collide. If so, a warning signal is generated. U.S. Pat. No. 6,529,831 further proposes the use of map data about the location of streets. Thus for example, if it is determined that the vehicles are on roads that do not intersect, no warning is generated. Furthermore, the map data is used to determine the distance from the vehicles to intersections, which can be combined with the speed to determine when the vehicles will be at the intersections, in order to determine the likelihood of collision.

Selectivity is an important aspect of a system for warning about approaching priority vehicles. If such a system gives many false alarms users will start ignoring the warnings, making the system useless.

U.S. Pat. No. 7,446,674 provides for selectivity in that it transmits signals only to nearby vehicles. But not only vehicles are warned which are moving in the same direction as the priority vehicle are used, but also vehicles driving in the opposite direction on roads with dual carriageways or on other roads.

U.S. Pat. No. 6,529,831 improves the selectivity of the warning system in that no warnings are generated for vehicles that are not on collision course. As long as the vehicles do not reach their destination before the next intersection and the vehicles drive on straight at the intersections, the warning of a possible collision at the intersection may still be reliable. However, this system may still produce false alarms, or fail to give alarms. The alarm is not reliable beyond the intersection, or if the vehicles reach their destination before the intersection or turn off.

### SUMMARY

One aim is to provide an alerting system for priority vehicles having improved selectivity and thus having more effect.

A method according to claim 1 is provided. Herein use is made of a next part of a planned route of at least one of the first and second road vehicle to determine a possible coincidence of future locations of the first and second road vehicle according to the next part of the planned route. An alert is generated in response to a determination of a possible collision according to next part of the planned route.

The planned route should be distinguished from mere speed data. Typically, the planned route is used by a navigation system to control generation of driving directions to a driver. The planned route gives an indication of voluntary future driver actions rather than the merely mechanical information provided by the vehicle speed. Thus for example, if the planned route of a priority vehicle indicates that the priority vehicle will stop at an address before a next intersection, or turn off at a next intersection, it can be avoided that an alert is generated in road vehicles whose route only crosses the road that goes straight on from the next intersection, or which are on that road. Similarly, it can be avoided that an alert is generated in road vehicles whose route only crosses a road that turns off from the intersection, unless the priority vehicle plans to turn off into that road.

In an embodiment, the planned route is expressed in terms of a sequence of way points, successive way points corresponding to successive intersections of roads along the planned route. In this case at least the next two waypoints of the planned route from the current position may be used in the determination of a possible collision. In this way it is possible to generate an alert dependent on whether a road vehicle plans to turn off from a road or not.

In an embodiment the data indicating a current position of a road vehicle, such as the priority vehicle and the next part of the planned route for the road vehicle may be transmitted to one or more other vehicles. Thus it can be determined in each of these other vehicles for that other vehicle whether a collision between with the transmitting (priority) vehicle is possible. Alternatively the determination could be performed in a station outside the other vehicle, using data from the other vehicle, the alert being transmitted to the other vehicle from the station if needed. But transmission of the data to the vehicle provides for a faster and more reliable response. Preferably, data about the planned route of the (priority) vehicle is transmitted. Otherwise only the planned route of the receiving vehicle may be used.

In a further embodiment planned routes of both road vehicles are used for determining a possible coincidence of future locations of the first and second road vehicle according to the next part of the planned routes of the first and second road vehicle.

According to an aspect a system for alerting a user of a first road vehicle (B-F, 4) about an approaching second road vehicle (A, 1) according to claim 8 is provided. This system may be used in the vehicle where the alter is generated, for example about the approaching priority vehicle.

### BRIEF DESCRIPTION OF THE DRAWING

Hereinafter these and other objects and advantageous aspects will become apparent from a description of exemplary embodiments.

FIG. 1 shows part of a map, including the positions of a priority vehicle and some common road vehicles;

FIG. 2 shows an illustration of an exemplary embodiment of system arranged for data exchange and processing between and in the vehicles concerned.

### DETAILED DESCRIPTION OF EXEMPLARY EMBODIMENTS

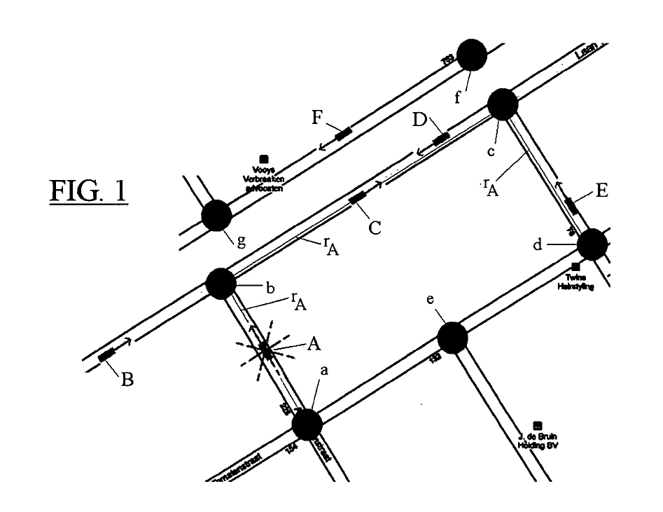

FIG. 1 shows part of a city map, including the positions of a priority vehicle A and some common road vehicles B-F.

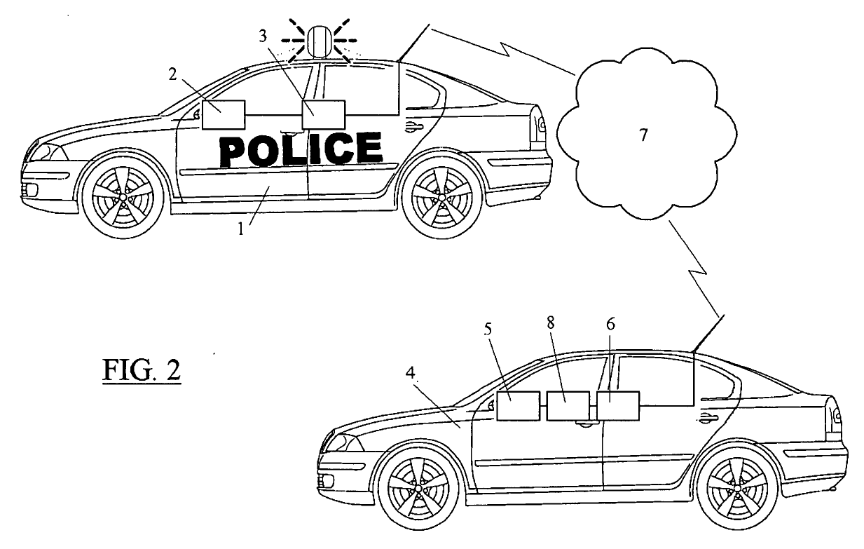

FIG. 2 shows an illustration of an exemplary embodiment of a system arranged for data exchange and processing between and in the vehicles concerned. A priority vehicle 1 (A in FIG. 1) is provided with first navigation system 2, a transmitter 3 arranged to transmit, either directly or indirectly, the first data to a road vehicle and/or its user. Each road vehicle 4 (B-F in FIG. 1) is provided with second navigation system 5 a receiver 6 data from the priority vehicle. Further, processing means 8 are arranged in (each) vehicle 4 to compare the data from the vehicles and providing that an (e.g. audible and/or visible) alert. The processing means 8 may comprise a processor (e.g a computer) and an alert rendering device, such as a loudspeaker or a display light.

In FIG. 1, several waypoints are shown, indicated as a-g, corresponding to road crossings in the road network. As used herein, waypoints are nodes in a road network wherein a driver of a road vehicle has a choice of a plurality of directions to continue driving, such as intersections of roads. FIG. 1 illustrates a situation that priority vehicle A approaches a crossing, indicated by waypoint b. The next part of the planned route (marked rA) of priority vehicle A—stored in its route planner—is waypoint b, turning to the right towards waypoint c, turning to the right towards waypoint d.

A (non-priority) road vehicle B approaches crossing b from another direction. A vehicle C drives between waypoints b and c; a vehicle D drives from waypoint c towards b; a vehicle E drives towards the crossing marked by waypoint c; a vehicle F drives between waypoints f and g. It is presumed that vehicles B, C and D should be alerted to the approach of priority vehicle A. If the road between waypoints b and c would be a dual carriageway, however, vehicle D should not be alerted. Vehicle E should or should not be alerted, depending on the distance between vehicles E and A. It is possible that vehicle E is not alerted initially; if, however, vehicle E would be delayed, an alert could be generated as yet. Vehicle F should not be alerted.

According to one aspect, first data, referring to the current position of the priority vehicle A and/or the next part of its planned route rA, are transmitted to all road vehicles and/or their drivers at least in the neighbourhood of vehicle A, thus including vehicles B-F. Said next part of the planned route of the priority vehicle A covers, for instance, the next two waypoints of its route, i.e. waypoints b and c. Those first data, e.g. represented by <b-c>, are transmitted either locally, regionally or nationally and are intended to be received by e.g. the navigation receivers and/or radio receivers installed in the vehicles or—separately—held by their drivers. The first data may be transmitted to those receivers directly, i.e. by means of a transmitter installed in the priority vehicle, or indirectly, via any broadcast network. In the latter case the planned route of the priority vehicle has to be transmitted first to any node or server of such broadcast network. Direct transmission has the advantage that the delay between transmission and reception can be made smaller, reducing the duration of the time interval for which the data has to provide reliable prediction. Said first data may be formatted in conformity to the RDS-TMC and related standards.

Each road vehicle B-F, via its installed receiver, or its user, via his/her personal receiver, receives the first data <b-c> from vehicle A (directly or indirectly, via any wireless network) and compares them to second data, referring to the current position of the road vehicle (or its user) and/or the next part of its route.

In an embodiment wherein the next part of the route is used, for vehicle B those second data can be represented in the example by <b-c>, for vehicle C<c-w> (waypoint w being any next waypoint after waypoint c, which could be waypoint d), vehicle D<b-x> (waypoint x being any next waypoint, which could be waypoint a), vehicle E<c-y> (waypoint y being any next waypoint, which could be waypoint c), and vehicle F<g-z> (waypoint z being any next waypoint after waypoint g). So the first and second data are compared in all those vehicles B-F:

| | |
|---|---|
| 1. | B <b-c> is compared with A <b-c>, resulting in a match of waypoints |
| | b and c |
| 2. | C <c-w> is compared with A <b-c>, resulting in a match of waypoint c |
| 3. | D <b-x> is compared with A <b-c>, resulting in a match of waypoint b |
| 4. | E <c-y> is compared with A <b-c>, resulting in a match of waypoint c |
| 5. | F <g-z> is compared with A <b-c>, resulting in no match of waypoints |

In the cases 1-4 an alert is output to the users and/or the road vehicles B-E, as the comparison of the first and second data indicates that any position within the next part—i.e. between the first and second next waypoints b and c—of the planned route of the priority vehicle coincides with any position within the next part of a planned route of the road vehicle.

In the embodiment wherein also the current position of each vehicle is taken into account, not only their two next two waypoints may be exchanged and compared, but also their last passed waypoints (as the vehicles' current positions always will be located between their last passed waypoint and their next waypoint). The matching results would then look like:

| | |
|---|---|
| 1. | B <o-b-c> is compared with A <a-b-c>, resulting in a (double) match of |
| | waypoints b and c |
| 2. | C <b-c-w> is compared with A <a-b-c>, resulting in a (double) match of |
| | waypoints b and c |
| 3. | D <c-b-x> is compared with A <a-b-c>, resulting in a (double) match of |
| | waypoints b and c |
| | (however in opposite direction, which, arbitrary, could or could not be |
| | considered as a match); |
| 4. | E <d-c-y> is compared with A <a-b-c>, resulting in a single match of |
| | waypoint c |
| | (which single match, arbitrary, could or could not be considered as a |
| | match); |
| 5. | F <f-g-z> is compared with A <a-b-c>, resulting in a no match of |
| | waypoints. |

From the above table it may be clear that a decision should be made—in the matching software—whether (see FIG. 1) vehicles D and E should or should not be alerted to the approach of priority vehicle A, as vehicle D drives on the oppositely to vehicle A and vehicle E is still at a large distance from vehicle A.

In the embodiment wherein the second data refers to the current position of the road vehicle (or its user), the road section that contains the current position may be determined and it may be tested whether the planned route of the priority vehicle contains that road section or crosses it.

As shown in the embodiment of FIG. 2 a priority vehicle 1 (A in FIG. 1) is provided with first navigation means 2 (a navigation system that contains a planned route), arranged to provide first data (e.g. <a-b-c>, see FIG. 1) referring to the current position (viz. between waypoints a-b) and/or the next part of its route (viz. waypoints b-c), as well as transmission means 3 (a transmitter) arranged to transmit, either directly or indirectly, the first data to a road vehicle and/or its user.

Each road vehicle 4 (B-F in FIG. 1) and/or its user (not shown) is provided with second navigation means 5, arranged to provide second data (e.g. <b-c-w>) for vehicle C), referring to the current position (viz. between waypoints b-c) and/or to the next part of its planned route (waypoints c-w), as well as receiving means 6 for receiving, either directly or indirectly, e.g. via any network 7, the first data from the priority vehicle. Further, processing means 8 are arranged in (each) vehicle 4 to compare the first (e.g. <a-b-c>) and second data (e.g. <b-c-w>) and providing that an (e.g. audible and/or visible) alert is output to the user when the comparison of the first and second data indicates any match (e.g. b and/or c) of, on one side, the current position or the next part of the planned route of the priority vehicle A (<a-b-c>) and, on the other side, the current position or the next part of the planned route of the road vehicle (<b-c-w> for vehicle C). As there is a match between the first and second data, viz. the waypoints b and c, the navigation system 5 installed in road vehicle C will output an alert to its driver, warning him/her for the approaching priority vehicle A.

As is known per se, the navigation systems 2, 5 of each road vehicle may each comprise a memory that stores a representation of a planned route of the road vehicle, for example in the form of a sequence of labels of waypoints along the route, or labels of successive road sections along the route (each road section being associated with a first and second waypoints at the start and end of the road section respectively). Navigation system 2, 5 may be configured to generate identifications of waypoints and/or road sections of the planned route dynamically, each time from a current position, a target position and map data that relates the positions to road sections and/or waypoints, the navigation system 2, 5 using a route planning algorithm to select at labels of least the next two waypoints and/or road segments of a planned route from the current position to the target position.

The navigation system 2 of the priority vehicle may be configured to give directions for following the planned route to the driver of the priority vehicle. For this purpose the navigation system 2 may comprise a display screen and/or audio output, navigation system 2 controlling output of directions by the display screen and/or audio output dependent on the planned route. The navigation system 2 of the priority vehicle supplies the labels of at least the next two waypoints of its planned route to transmitter 3. Transmitter 3 inserts the labels or information therefrom in a message and transmits the message by means of a wireless signal.

The receiver 6 of another road vehicle receives the message and extracts the labels or data derived from the labels from the message. The extracted information is supplied to processor 8. The navigation system 5 of the road vehicle determines a road section on which the road vehicle is located. The navigation system 5 of the road vehicle may comprise a GPS receiver and a storage device containing map data that relates positions to road sections. In this case, navigation system 5 may use positions determined by the GPS receiver to look up a label of a road section on which the vehicle is driving and or labels of waypoints at the beginning and end of the road section. Navigation system 5 supplies this information to processor 8. Processor 8 operates under control of a computer program that makes it compare the data received from the priority vehicle (e.g. <a-b-c>) and the data from the navigation system 5 of the vehicle (e.g. <b-c-w>). Processor 8 may determine whether the data received from the priority vehicle indicates that the priority vehicle is on the same road section as the vehicle containing processor 8, travelling in the same direction, or will be on that road section after passing its next waypoint, travelling in the same direction. This may be done by testing whether the labels w1, w2 of the waypoints between which the vehicle is travelling equal the labels w1′, w2′ of the waypoints between which the priority vehicle is travelling according to the received message, or the labels w1, w2 equal the labels w2′, w3′ of the waypoints between which the priority vehicle will next be travelling according to the received message. If so, processor 8 may control an alert device of processor 8, such as an audio output device or a light output device (not shown separately in the figure) to render an alert in the vehicle.

Furthermore, processor 8 may determine whether the data received from the priority vehicle indicates that the priority vehicle will cross an intersection that the vehicle of processor 8 will cross. This may be done by testing whether the label w2 of the waypoint of the intersection that the vehicle will cross next equals the label w2′, w3′ of an intersection that the priority vehicle will cross. If so, processor 8 may control the alert device to render the alert in the vehicle. Processor 8 may be configured to refine this test for example to determine whether the direction taken by the priority vehicle at the intersection may give rise to a risk of collision. This may involve testing whether the priority vehicle and the vehicle with the processor 8 are heading to a same intersection (waypoint). This may involve testing whether the priority vehicle will arrives at the intersection from a direction opposite to that of the vehicle with the processor 8, and the planned route of the priority vehicle involves a turn that will cross in front of the road section where the vehicle of processor 8 is driving (a left turn in countries where vehicles drive right) and generating an alert if this is the case. This may furthermore involve testing whether the priority vehicle comes from direction that crosses the direction of the vehicle with the processor 8, and the planned route of the priority vehicle involves driving straight on, or turning only after crossing in front of the road section where the vehicle of processor 8 is driving, and generating an alert if this is the case.

If the priority vehicle has a destination along its current a road section or the next road section of its planned route, there is no need to generate an alert for possible crossing at an intersection at the end of a road section beyond the destination. The navigation system 2 of the priority vehicle may indicated this by including information in the message that it will not proceed to the next intersection, or omitting further waypoints, and the processor 8 of the other vehicle may be programmed to respond to this information by suppressing or preventing the generation of an alert for a possible meeting at the next intersection at the end of the road section where the priority vehicle is driving.

If the vehicle with the processor 8 also drives under direction of a planned route, this planned route may also be used to determine whether an alert must be generated. Processor 8 may use waypoints of the planned route of the vehicle to determine the road section on which the road vehicle is current travelling, for use in the determination described in the preceding. The label w3 of waypoint of the planned route of the vehicle beyond the next intersection may be used to with the processor 8 can be compared with the label of a future waypoint w3′ of the priority vehicle to determine whether or not an alert should be generated, for example if the next planned road section of both vehicles are equal (road sections w2-w3 and w2′-w3′ and w2=w2′ and w3=w3′).

Although use of a planned route for both the priority vehicle and other vehicles can help to improve selectivity, it should be noted that selective warnings can be generated also without planned routes of the other vehicles, using the planned route of the priority vehicle. It is advantageous that it is not required that every road user uses route planning.

In a further embodiment timing of the planned routes may be taken into account. Generation of the alerts may be disabled if the expected crossing or presence on a same road section is more than a predetermined amount of time in advance, and/or if the vehicles are not expected to be there within a same time interval. Processor 8 may use a measured current speed of the vehicles, their current positions and map data of the distance from the current positions to the next waypoint to compute estimated travel times to the waypoint. Processor 8 may disable the alert for crossing at the waypoint or road sections beyond the waypoint for example as long as any one of the expected travel times exceeds a first threshold value, and/or if the estimated travel times from the current time differ by more than a second threshold value. Instead of a current speed, map data indicating a speed limit on the road section may be used for computing the travel time for at least one of the vehicles. This makes it unnecessary to use speed measurements even it timing is used. It has been found that in practice the speed limit suffices to get a useful estimate. However, it should be noted that even without timing information for which speed information is needed selective warnings can be generated when only a limited number of future waypoints of the planned route is used to decide about the alert (e.g. only two). In typical environments where alerts about priority vehicles are most needed (within cities) use of such a limited number implicitly imposes a time window.

Although embodiments have been shown wherein the decision about the alert is determined by the processor 8 in the vehicle that is warned, it should be appreciated that it may also be determined elsewhere, for example outside the vehicle. However, it is advantageous to do so in the vehicle, because this makes it possible to generate warnings without transmitting data about vehicle position and/or the planned route from the vehicle that is warned. Processor 8 may be part of the navigation system 5 of the vehicle, or a separate processor. Although an example has been mentioned wherein the vehicle position is determined by means of a GPS receiver, it should be appreciated that other determinations could be used, using other position determining systems, beacons along the road, identification of mobile telephone cells from which signals are received at the vehicle, or dead reckoning based on measured vehicle movement. Although an embodiment has been shown wherein a vehicle bound navigation system 5 is used in the vehicle where the alert is generated, it should be appreciated that the determination whether the alert should be generated and/or generation of the alert could be performed by a portable device of the user, such as a mobile telephone. When provided with map data and messages with planned route information from a priority vehicle, such a device may perform the determination as described.

According to one aspect a method for alerting a user of a road vehicle (B-F, 4) for a neighbouring priority vehicle (A, 1) is provided, comprising the steps of:
providing that first data, referring to the current position of the priority vehicle and/or the next part of its planned route, are transmitted to the road vehicle and/or its user;
providing that the road vehicle and/or its user receives said first data and compares them to second data, referring to the current position of the road vehicle and/or the next part of its planned route;
providing that an alert is output to the user when the comparison of the first and second data indicates that the current position or any position within the next part of the planned route of the priority vehicle coincides with the current position or any position within the next part of a planned route of the road vehicle. In an embodiment, said next part of the planned route of the priority vehicle or road vehicle respectively covers at least the next two waypoints of its route. In an embodiment said current position of the priority vehicle or road vehicle respectively may be represented by the last passed waypoint and the next waypoint of its route.

In an embodiment the format of the first and second data meet the RDS-TMC and/or Alert C standards. The user may be alerted by means of his or her radio receiver and/or navigation system. The first data may be broadcasted directly to any road vehicle in the priority vehicle's neighbourhood. Alternatively the first data may be broadcasted to any relevant road vehicle via any suitable broadcast system.

According to an aspect a system is provided for alerting a user of a road vehicle (B-F, 4) for a neighbouring priority vehicle (A, 1), wherein the priority vehicle is provided with
first navigation means (2), arranged to provide first data, referring to next part of its planned route, and
transmission means (3) arranged to transmit, either directly or indirectly, said first data to the road vehicle and/or its user;
   wherein the road vehicle and/or its user is provided with
second navigation means (5), arranged to provide second data, referring to next part of its planned route, and
receiving means (6) for receiving, either directly or indirectly, said first data from the priority vehicle, and
processing means (8), arranged to compare the first and second data and providing that an alert is output to the user when the comparison of the first and second data indicates a match of, on one side, the current position or the next part of the planned route of the priority vehicle and, on the other side, the current position or the next part of the planned route of the road vehicle. In an embodiment the first navigation means are enabled to process waypoints (a-g) and wherein the next part of the planned route of the priority vehicle covers at least the next two waypoints of its route and wherein the current position of the priority vehicle is represented by its last passed waypoint and its next waypoint.

In an embodiment the second navigation means are enabled to process waypoints and wherein the next part of the planned route of the road vehicle covers at least the next two waypoints of its route and wherein the current position of the road vehicle is represented by its last passed waypoint and its next waypoint. The first navigation means and/or the second navigation means and/or the processing means may be arranged to process the first and second data meeting the RDS-TMC and/or Alert C standards. A radio receiver and/or navigation system of the user and/or the road vehicle may be comprised in or linked to said processing means and may be arranged to alert the user when said comparison of the first and second data indicates said match.

According to one aspect the method and system are based on but not limited to the use of nowadays vehicle navigation and/or route planning systems in priority vehicles and/or other road vehicles, wherein the relevant positions and/or (part of) the planned route of the priority vehicle is distributed to other users and compared with the user's planned route and an alert is given when they match.

According to one aspect a method for alerting a user of a road vehicle for a neighbouring priority vehicle, provided that comprises the steps of:
providing that first data, referring to the current position of the priority vehicle and/or the next part of its planned route, are transmitted to the road vehicle and/or its user;
providing that the road vehicle and/or its user receives the first data and compares them to second data, referring to the current position of the road vehicle and/or the next part of its planned route;
providing that an alert is output to the user when the comparison of the first and second data indicates that the current position or any position within the next part of the planned route of the priority vehicle coincides with the current position or any position within the next part of a planned route of the road vehicle.

For instance, the next part of the planned route of the priority vehicle may cover at least the next two waypoints of its route. The next part of the planned route of the road vehicle may also cover at least the next two waypoints of its route. Waypoints may be defined as sets of coordinates that identify a point in physical space. For the purposes of terrestrial navigation, these coordinates usually include longitude and latitude, and sometimes altitude (particularly for air navigation). Waypoints have become widespread for navigational use since the development of advanced navigational systems, such as the Global Positioning System (GPS) and certain other types of radio navigation. GPS systems are increasingly used to create and use waypoints in navigation systems. A typical GPS based navigation device (receiver, terminal) can locate a waypoint with an accuracy of some meters. Waypoints can also be included in a computer mapping program and uploaded to such a navigation device, marked on the device's internal map or entered manually into the device as pairs of coordinates. In GPS navigation systems, a “route” is usually defined as a series of two or more waypoints. To follow such a route, the GPS user navigates to the nearest waypoint, then to the next one in turn, until the destination is reached.

Preferably, the formats of the first and second data meet the RDS-TMC and/or Alert C standards.

RDS (Radio Data System) is a communications protocol standard for embedding small amounts of digital information in conventional FM radio broadcasts. The RDS system standardises several types of information transmitted, including time, station identification and programme information. RDS-TMC (Traffic Message Channel) is a technology for delivering traffic and travel information to drivers. It is typically digitally coded using the FM-RDS system on conventional FM radio broadcasts. It can also be transmitted on DAB or satellite radio. It allows silent delivery of high quality accurate, timely and relevant information, in the language chosen by the user and without interrupting normal services. Services, both public and commercial, are operational now in many countries worldwide. When data is integrated directly into a navigation system, this gives the driver the option to take alternative routes to avoid traffic incidents. Each traffic incident is sent as a TMC message. One message consists of an event code and a location code in addition to time details.

The message is coded according to the Alert C standard. It contains a list of max 2048 events (1402 pr 01.02.2007) which can be translated by a TMC receiver into the language of the user.

Location code tables are maintained on a national level and assign numbers to locations on the road network. Those location tables are integrated in the maps provided by NAVTEQ© and Tele Atlas©.

The user (driver) of the road vehicle may preferably be alerted by means of its radio receiver and/or navigation system.

The first data may be broadcasted directly by the priority vehicle to the road vehicles in its neighbourhood. As an alternative the first data may be broadcasted to the road vehicles via any suitable broadcast system, e.g. a national, regional or urban radio broadcast system.

When it is determined that the vehicles will be on a same road section or on a same intersection it can be said that a collision is possible. A computer program product, such as a magnetic or optical disk or a semiconductor memory may be provided with instructions for a programmable computer may be provided, to make processor 8 perform the described method, including inputting the data about the planned route of the priority vehicle, determining whether the alert should be generated and sending a control signal to an alert device to render the altert.

1. A method of alerting a user of a first road vehicle (B-F, 4) about an approaching second road vehicle (A, 1), comprising the steps of:
generating a planned route to be followed by at least one of the first and second road vehicle;
comparing information derived from current positions of the first and second road vehicle, using a next part of the planned route of at least one of the first and second road vehicle to determine a possible coincidence of future locations of the first and second road vehicle according to the next part of the planned route;
outputting an alert in the first road vehicle to its user when the comparison indicates a possible collision according to next part of the planned route.

2. A method according to claim 1, wherein a planned route is generated for the second road vehicle, first data indicating a current position and/or current part of the planned route of the second road vehicle and the next part of the planned route for the second road vehicle, the first data being transmitted from the second road vehicle and received by the first road vehicle, said comparing being performed in the first road vehicle based on the received first data.

3. A method according to claim 2, wherein a planned route is generated for the first road vehicle, said comparing being performed in the first road vehicle based on the received first data, to determine a possible coincidence of future locations of the first and second road vehicle according to the next part of the planned routes of the first and second road vehicle.

4. A method according to claim 1, wherein the planned route comprises way points, said next part of the planned route that is used in said comparing covering at least the next two waypoints of the planned route from the current position.

5. A method according to claim 1, wherein first data indicating a current position of the second road vehicle and the next part of the planned route for the second road vehicle is transmitted from the second road vehicle, the first data being transmitted the format of the first and second data meet the RDS-TMC and/or Alert C standards.

6. A method according to claim 1, wherein the user is alerted by means of its radio receiver and/or navigation system.

7. A method according to claim 1, wherein first data indicating a current position of the second road vehicle and the next part of the planned route for the second road vehicle is transmitted from the second road vehicle, the first data being broadcast directly to any road vehicle within reception range from the second vehicle.

8. A system for alerting a user of a first road vehicle (B-F, 4) about an approaching second road vehicle (A, 1), wherein the system comprises
a receiver configured to receive a transmission of first data from the second road vehicle, the first data comprising an indication of a current position of the second vehicle and the next part of the planned route for the second vehicle;
an alert signal rendering device;
a processor (8), configured to compare the first data with second data derived from a current position of the first road vehicle, using the next part of the planned route of the second road vehicle to determine a possible coincidence of future locations of the first and second road vehicle according to the next part of the planned route and to cause the alert signal rendering device to alert the user of the possible collision when the comparison of the first and second data indicates a possible collision.

9. A system according to claim 8, comprising a route planning sub-system, configured to generate a planned route for the first vehicle, the processor (8), being configured to use the next part of the planned routes of the first and second road vehicles to determine a possible coincidence of future locations of the first and second road vehicle according to the next parts of the planned routes of the first and second road vehicles.

10. System according to claim 8, wherein the planned route comprises waypoints (a-g), the next part of the planned route of the second road vehicle covering at least the next two waypoints of its route.

11. System according to claim 1, wherein the receiver and/or the processor are configured to process the first data according to the RDS-TMC and/or Alert C standards.

12. A system for alerting a user of a first road vehicle (B-F, 4) about an approaching second road vehicle (A, 1), wherein the system comprises
a navigation system in the second road vehicle, configured to determine a current position of the second vehicle and to give route directions in the second vehicle, according to a planned route of the second road vehicle;
a transmitter configured to transmit first data from the second road vehicle, the first data comprising an indication of a current position of the second vehicle and a next part of the planned route for the second vehicle.

13. A system according to claim 12, wherein the transmitter is configured to transmit the first data using the RDS-TMC and/or Alert C standards.
